(19) United States
(12) Patent Application Publication
(10) Pub. No.: US 2003/0110185 A1
(43) Pub. Date: Jun. 12, 2003

(54) Geographically-based databases and methods

(76) Inventor: Geoffrey B. Rhoads, West Linn, OR (US)

Correspondence Address: DIGIMARC CORPORATION, 19801 SW 72ND AVENUE, SUITE 100, TUALATIN, OR, 97062, US

(21) Appl. No.: 10/013,829

(22) Filed: Dec. 10, 2001

(51) Int. Cl. G06F 7/00

(52) U.S. Cl. 707/104.1

(57) ABSTRACT

As more and more digital data is generated, the need to organize and index same in an orderly fashion increases. Much of this data has a geographical aspect, e.g., a photograph may depict a particular place, or a school newspaper may be published in a particular town. In collections of such data, geographical attributes can sometimes provide convenient organizational keys. In one embodiment, a database is structured to exploit geographical attributes as keys to physical data storage. Data objects (photos, newspaper articles), per se, are not stored in this geographical structure, but are rather represented by virtual “push pin” markers that are stored in memory in accordance with their geographical associations. Such markers literally express some attributes of the corresponding data object, and provide pointers to external locations where additional data can be found. A number of other novel features and arrangements are also detailed.

### FIELD OF THE INVENTION

The present invention relates to database design and methodology, and more particularly relates to databases containing geographically-related data.

### BACKGROUND OF THE INVENTION

As more and more digital data is generated, the need to organize and index same in an orderly fashion increases. Much of this data has a geographical aspect, e.g., a photograph may depict a particular place, or a school newspaper may be published in a particular town. In collections of such data, geographical attributes can sometimes provide convenient organizational keys.

In accordance with one embodiment of the present invention, a database is structured to exploit geographical attributes as keys to physical data storage. Data objects (photos, newspaper articles), per se, are not stored in this geographical structure, but are rather represented by virtual “push pin” markers that are stored in memory in accordance with their geographical associations. Such markers literally express some attributes of the corresponding data object, and provide pointers to external locations where additional data can be found. A number of other novel features and arrangements are also detailed.

The foregoing and additional features and advantages of the present invention will be more readily apparent from the following detailed description, which proceeds with reference to the accompanying drawings.

### BRIEF DESCRIPTION OF THE DRAWINGS

FIG. 1 shows principle hardware components of a mapping system according to one embodiment of the invention.

FIG. 2 shows a “gore” of the sort employed in accordance with certain embodiments of the present invention.

FIG. 3 shows several gores.

### DETAILED DESCRIPTION

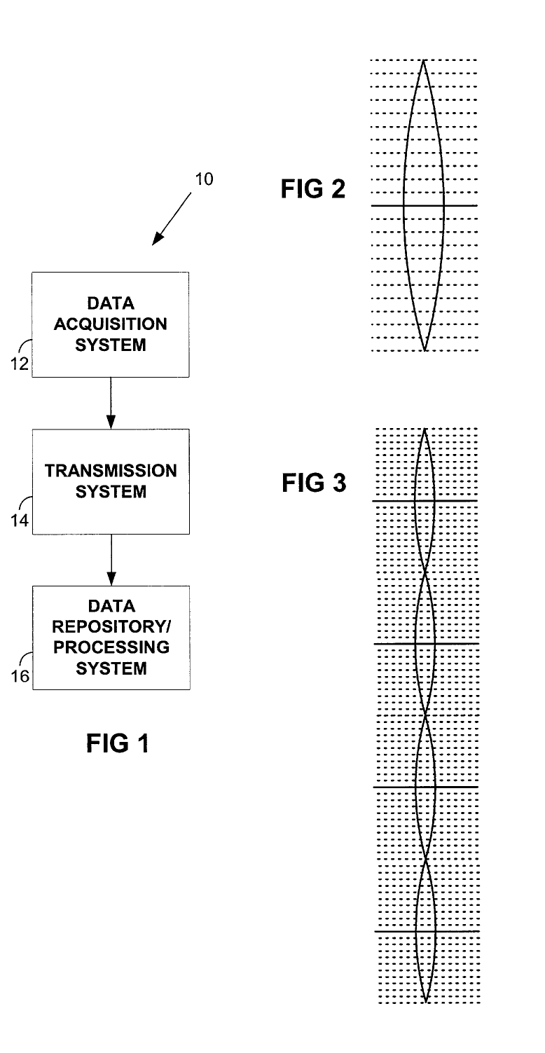

Referring to FIG. 1, a mapping system 10 according to one embodiment of the invention includes a data acquisition system 12, a transmission system 14, and a data repository/processing system 16.

The data acquisition system 12 can take myriad forms, including classical arrangements for acquiring geographical measurements and mapping data (e.g., transit-based surveying methods, aerial photography, and remote sensing). Arrangement such as those detailed in U.S. Pat. Nos. 5,608,405, 5,926,581, 5,974,423, 6,023,278, 6,177,943, 5,995,681, 5,550,937 and 6,150,972, and in pending application Ser. No. 09/800,093, filed Mar. 5, 2001, can also be used.

Data acquisition system 12 can also acquire data that is not typically associated with map generation, including audio recordings and text data, as well as other forms of data that may be associated with a geographical point or area.

The information from data acquisition system 12 is passed to the data repository/processing system 16 through the transmission system 14. In some embodiments, the transmission system can be a radio link. In others, wired (including Internet) channels can be used. In still other arrangements, there is no transmission system 14, per se. Instead, the input data is provided directly to the data repository/processing system 12.

The data repository/processing system 12 can take various forms, but most include conventional computer components such as one or more CPUs, volatile storage (e.g., RAM), non-volatile storage (e.g., ROM, fixed and removable magnetic disks, fixed and removable optical disks), interfaces (e.g., WAN, LAN, USB, modem, serial), input/output devices (e.g., monitor, keyboard, mouse, tablet, joystick, light pen), etc.

Associated with the processing system 12 is various software, including operating system software and database software. Applications software can be used—in conjunction with the database software—to perform various of the operations detailed below, or such operations may be effected directly through the database software.

It should be recognized that the depicted arrangement is illustrative only, and countless variations thereon are possible, including many employing parallel or distributed processing.

This discussion now terms to a functional view of an exemplary embodiment, without particularly tying certain functions to certain hardware (such association being within the capability of those ordinarily skilled in the art).

The detailed embodiment employs the construct of a virtual “push-pin.” In a basic embodiment, each push pin corresponds to one item of data (e.g., a photograph or text document), and serves, e.g., as a virtual geographical marker for such data.

The push pin can comprise 32 bytes of data (8 bits per byte) and is associated with a particular geographical location. This association is effected by storing the push pin in a data structure at a position within the data structure that is associated with the corresponding geographical location.

The data structure can be conventional, e.g., with storage organized in terms of a two-dimensional latitude/longitude paradigm. However, the preferred embodiment uses a more one-dimensional data organization based on “gores.”

In the depicted embodiment, a “gore” is a strip of land that starts at a point at one pole, becomes wider as it approaches the equator, and returns to a point at the opposite pole. A sample is depicted in FIG. 2 (with latitude lines shown in dashed; the equator is solid). Gores may be defined by reference to longitude. For example, a gore may comprise the land between longitudes 120 E and 121 E.

A feature of the gore approach is that gores can be end-to-ended with each other, as shown in FIG. 3. A gore from the north to south poles encompassing 120 E-121 E may continue across the south pole and span 40 W-41 W on the opposite side of the globe. Continuing again across the north pole, it can continue to encompass 121 E-122 E. And so on, until the entire globe is mapped to a series of end-to-ended gores.

By making the end-to-ended gores sufficiently narrow, a substantially one-dimensional mapping of the earth results. As applied to the data structure in which the push pins are stored, it too can be substantially one-dimensional. Database indexing and search techniques can be tailored to this substantially one-dimensional architecture, offering various advantages over traditional database organizations.

An illustrative embodiment may use gores having a width of 1 kilometer at the equator. About 40,000 such gores are needed to cover the earth.

Returning to the push pins, recall that each push pin is stored in the database and corresponds to a data object (photo, etc.) Some attributes of the data object may be represented literally within the 32 bytes (e.g., the object's creation date). Other attributes, and the full data object itself, may be stored externally of the push pin (e.g., the name of a person responsible for the data object, and the JPEG photo itself) and indexed by one or more identifiers (links) included within the 32 bytes. The size of the push pin thus reflects a compromise between the amount of data that is to be literally encoded within the push pin, and the amount that is stored externally. Data that is literally encoded within the push pin is available more quickly, and is more readily used in database indexing, etc. But encoding more data in each push pin swells the size of the database. Since some databases may include upwards of a million push pins, the size of the push pin can be critical to implementation costs.

Consider a geomapping database including aerial images. A few of the attributes literally encoded in a push pin for one of the images may include, e.g., image date, image time, image spectrum, image dimensions, visibility conditions, and image resolution. Additionally, the push pin may include one or more pointers to external storage at which other meta data (and the image itself) are stored.

Another attribute that may be relevant with some data objects is the “radius of interest” around a single geographical location. Temperature data taken at an airport weather station, for example, may be generally accurate for a zone of fifteen miles around the airport. In contrast, an audio recording made at one location may be relevant only for a zone of 10 meters therearound. This attribute may be among those literally encoded in the push pin.

Still another attribute that may be literally expressed in the push pin is location information, e.g., latitude, longitude, elevation. This is not always essential. For example, in some embodiments the longitude can be inferred from the gore in which the push pin is positioned, and the latitude can be inferred from the pin's placement within the gore.

Yet another attribute that may be literally expressed in the push pin is permission data, indicating the grades of users that are permitted to read data from the push pin, or link to associated data.

The literally-included attributes can be expressed in a compact form. For example, the visibility conditions may be expressed by 3 bits, representing 8 different states. Likewise, coded representations may be used for image resolution, with one state meaning features only larger than 100 m are visible, a second meaning features between 30 m and 100 m can be distinguished, a third meaning features between 10 m and 30 m can be distinguished, etc. Fuller, or more accurate, representation of any of these attributes can be included in the external storage indexed by the pointers.

The pointers can take various forms. One is an HTML link, which specifies a remote computer and storage address containing the additional information. Another is an integer that serves as an address in a table in which the additional information is stored. (The table may store HTML links to still other data repositories.)

The 32 bytes comprising a push pin are stored at a position in the database according to the gore and latitude to which the pin corresponds. At least gross information about the geographical area to which the data object corresponds can thus be inferred by the particular gore in which the pin is stored, and the pin's placement within the gore.

Once a database of push pins has been compiled, it can be indexed and searched in a variety of ways. Different users may be granted different permissions to search and view the database contents, and link to the data associated with the pins.

A variety of user interface techniques are available for interacting with the database. One displays a map of a region, with push pins shown by icons or other graphic indicia. (The map may be, e.g., a simple 2D outline, a complex 3D rendering, etc.) The icons may have different colors or shapes, revealing some of their attributes. One shape may denote an image object, another an audio object, another a text document, another a weather report, etc. Likewise, an icon presented in green may represent fresh data (e.g., within the past day or week), whereas an icon presented in brown may represent dated information (e.g., dating from a month or more ago). A spectrum of colors can be employed to indicate gradations in attributes.

In databases used for mapping purposes, it is sometimes helpful to have the icon indicate whether the associated data is characterized by earth-sphere-related placement alone (e.g., latitude/longitude, street address, etc.), or also includes an elevation component.

Filters may be invoked by the user to display only pins with certain attributes, e.g., aerial images taken in the infrared spectrum, having a resolution of 10 m or less, taken within the past three months, having a radius of interest that falls within Multnomah County, Oregon. When filtered, the colors and/or shapes used to represent the icons may be re-assigned to exploit the smaller set of pins being represented, to convey more detailed attribute information on inspection.

Clicking on a pin can open a window that details the literally encoded attributes, and/or links to external data identified by a link expressed in the pin.

The user interface may also permit users to select pins of interest from a larger displayed set by clicking on the corresponding icon, or “dragging” a square or circular border around a group of pins of interest.

Another form of user interface goes beyond the display of pins on a map. Instead, the system synthesizes data from the data objects represented by pins, and presents a visual (or audio, or multimedia) rendering of a subject of interest. A collection of aerial photos, for example, can be used to synthesize a virtual 3D model of terrain, which model can be inspected from any virtual vantage point. (See in this regard the arrangements disclosed in pending applications Ser. Nos. 09/800,093 (filed Mar. 5, 2001), and 09/______ (filed Nov. 28, 2001, attorney docket P0494, entitled Geographically Watermarked Imagery and Methods). Any known stereoscopic viewing technique, such as virtual reality goggles, or the arrangement shown in U.S. Pat. No. 6,195,069, can be utilized in such embodiment.

Desirably, the user interface is arranged to give the user full control on what is rendered. The rendering should include only the information the user needs, with extraneous information omitted. Tools permitting the user to dynamically increase or decrease the data contributing to the rendering allow, e.g., a series of subjects of interest to be sequentially focused upon. A camera paradigm may be employed, with zoom-in/zoom-out features, and panning to change focal point to different subjects.

In the illustrative embodiment, the database has a physical memory organization that mirrors the gores, e.g., ordered north-to-south. The mapping between latitude and memory addresses typically is not uniform. For example, in the gore that passes through London, most of the data entered in the database will have a latitude coordinate around London's latitude of 59.7 degrees north. A polynomial can express the mapping function between the linear memory space and the corresponding latitude—taking into account the dense “pin stuffing” that will occur in areas of interest.

Desirably, the polynomial can be adapted over time to reflect the actual pin density distribution through each gore, swelling the allocated memory where pin density grows, and contracting where pin density is reduced or is found to be less than originally expected. This adaptation can be performed in a variety of ways. It can be scheduled (e.g., daily), or invoked manually. Or it can be triggered when a new pin is to be added, and the existing memory mapping provides no space for the new pin.

Of course, the memory allocation needn't be done with a mathematical expression such as a polynomial. Other techniques can be used. For example, for any given gore, each interval of latitude (e.g., 0.5 degrees) may be assigned a fixed memory allocation to fit a small number of pins (e.g., 10 pins, 320 bytes). A single gore may thus initially be allocated 180*320, or 57,600 bytes of storage. As the database is populated with data, the gore's storage is increased, and these fixed allocations can be changed so as to provide ample headroom for expected growth. (The headroom may be ensured by a variety of techniques, e.g., fixing it uniformly across the gore, such as always keeping 10 open pin spaces per interval of latitude, or by having a percentage (15%) of filled memory usage for a given latitude interval that is allocated for future pins—allowing more headroom for latitudes with high pin densities, etc.) When the polynomial—or other allocation arrangement—is changed, the existing pins can be moved as necessary within the memory to conform to the new memory allocation. This can be done by shuffling data within a single physical memory. Alternatively, two memories (or databases) can be used. When a reallocation is required, data is copied from the first memory (using the old allocation) into a new memory (using the new allocation). When, thereafter, a further reallocation is required, the process can similarly copy data from the second memory back into the (reallocated) first. And so on. Mirrored databases can be used in this manner—with the same data stored in both, just according to different allocations.

The database may be constructed with the philosophy that “pins are cheap.” Push pins may be assigned to any data object having a geographical association or aspect. Some physical objects may involve many pins, such as rivers or territorial borders whose meandering courses are memorialized every hundred yards by a different pin.

Searching the database may proceed on a geographical proximity basis. Consider a search for information relating to the town of Troutdale, Oreg. The latitude and longitude of Troutdale (45.539 N, 122.386 W) are provided to the system (e.g., by manual, typed entry, by pointing using a pointing device on a displayed map, by specifying the city name, by another computer system, etc.) and the system first determines the range of memory addresses at which pins corresponding to that latitude/longitude are stored. (The database may have an index specifying, for example, the starting address at which the gore encompassing latitude 122.386 W is represented. For that gore, the database may have a second index correlating particular latitude intervals to particular ranges of physical memory. It may thus determine that pins associated with the latitude interval 45.5 N-46 N are stored in a particular range of physical memory.) Pins within this determined range can be checked against any specified filtering parameters (e.g., meta-data associated with the object must include the word “Troutdale,” or its specified “radius of interest” must encompass 45.539 N, 122.386 W) and output to a rendering engine (e.g., for display as push pin icons on a virtual map, or for transformation into a synthetic display of some sort). The operator may thus be presented information including images of Troutdale, population data, school names, zip codes within the town, etc.

Having thus started providing the user with useful feedback, the system can continue its search at memory locations surrounding the specified latitude/longitude. Immediately, it can check memory locations above and beyond the memory range first specified, within the same gore, corresponding to positions adjoining Troutdale in a north-south direction. Each push pin encountered in this expanded search is checked for its “radius of interest” to see if it encompasses 45.539 N, 122.386 W. (Alternatively, its meta-data can be checked for the term “Troutdale”). Data for any push pins found to meet the screen are added to the information presented to the user.

After, or while, the original gore is being checked for locations to the north and south of Troutdale, east- and west-adjoining gores can be similarly successively checked—first consulting each gore's memory to determine the range of memory where pins having latitude 45.539 are stored, and then working north and south from there. Such a search would soon encompass memory having pins associated with Portland, Oreg.—15 kilometers to the west—the county seat of Multnomah county in which Troutdale is located. In this memory range the search may find a number of pins with information about the county, including federal census information, weather information etc. Pins representing articles from the Oregonian newspaper may also be stored here. All such data is screened as specified by the operator and used to augment, as appropriate, the outputted information.

As the proximity search extends further outward from Troutdale, it encompasses the state capital of Salem—75 kilometers to the south. Here state-wide statistical data may be stored, and used to augment the information presented to the user if it meets the specified screens.

Eventually, the data contributed by such a progressive search reaches the point of diminishing returns, so the search is stopped before the entire globe is screened. The stopping point can be specified in a number of ways. For example, it can be specified by the user (e.g., don't look more than 20 miles away for information). Or it can be specified based on processor time (e.g., search for 8 seconds, then stop). Or it can be specified based on relevance (e.g., search until the quality, or rate, of finding relevant search results falls below a specified threshold), etc.

In large systems according to the present invention, it is expected that a large database will be maintained at a central (or distributed) processing facility, and it will be accessed by plural users equipped with individual computers. The allocation of processing can be distributed between the central station and the user stations as may be necessary to make most efficient use of available resources. For example, the central processing facility may simply pass all pins it finds in relevant memory locations to the applicable user station. The user station can then filter, link to external data, render as appropriate, etc. In other arrangements, some or all of these functions performed by the user workstation can be performed by the central system instead.

To provide a comprehensive disclosure without unduly lengthening this specification, applicant incorporates by reference the patents and patent applications referenced above.

Having described and illustrated the principles of the invention with reference to illustrative embodiments, it will be recognized that the invention can be modified in arrangement and detail without departing from such principles.

For example, although the illustrated embodiment employed push pins of 32 bytes, there is nothing magic about this figure—larger or smaller virtual markers can be used, depending on the application requirements and functionality desired. Moreover, it is not essential that a push pin be associated with a single geographical location. In other embodiments, a push-pin can be associated with several locations. This can be effected by replicating the push-pin and storing at each corresponding database position, or by storing a single push-pin at one database position together with shorter pointers thereto at other positions, or by other techniques. Still further, it is not essential that a push pin correspond to only a single item of data. In many embodiments, a push pin may be used to represent several related items. Or a single push pin can represent a group of other push pins.

While it may have been implied that the detailed embodiment indexed proprietary data objects (e.g., images acquired by the system proprietor), this need not be the case. A state or other agency may compile a geographical database that links to a variety of third party data objects, such as third party web pages and pictures found on the internet. More generally, the database system may not be closed—for the exclusive use of a particular company or government agency. Such a database system may instead be open to the public, with everyone invited to add push pins to the collection to enrich a growing knowledge base.

As noted, the illustrative embodiment employs a database memory arrangement that mirrors the gores. However, this is not essential, and other aspects of the illustrative embodiment can be utilized without this feature.

While most of the push pins are used to refer to external data objects, this is not essential. Some data may be adequately represented by data within the push pin itself—without external reference. A marker point along a territorial boundary is one example of a push pin that may not have a separate data object associated with it.

Although reference was made to gores (and corresponding memory) being ordered N-S, followed by S-N, followed by N-S, etc., this is not essential. Other arrangements can naturally be used, including all N-S.

In view of the many embodiments to which the principles of the invention may be applied, it should be recognized that the detailed embodiments are illustrative only and should not be taken as limiting the scope of the invention. Rather, I claim as my invention all such embodiments as fall within the scope and spirit of the following claims, and equivalents thereto.

I claim:

1. A database comprising a physical memory, the physical memory being allocated into ranges, each range having a geographical gore associated therewith, the database including plural virtual markers stored therein, each marker having a latitude and longitude associated therewith, each marker being stored in a physical memory range associated with its associated longitude, at a position within said range dependent on its associated latitude.

2. The database of claim 1 wherein one of said virtual markers includes data specifying characteristic attributes of a data object associated therewith, and a pointer to externally stored data

3. The database of claim 2 wherein the pointer comprises a pointer to an external storage location at which the data object itself is stored.

4. The database of claim 2 wherein the pointer comprises a pointer to an external storage location at which meta data about the data object is stored.

5. The database of claim 2 wherein the marker includes data specifying a date attribute.

6. The database of claim 2 wherein the marker includes data specifying an image spectrum attribute.

7. The database of claim 2 wherein the marker includes data specifying a visibility condition attribute.

8. The database of claim 2 wherein the marker includes data specifying an image resolution attribute.

9. The database of claim 2 wherein the marker includes data specifying a radius of interest attribute.

10. The database of claim 2 wherein the marker includes data specifying at least two location coordinates.

11. The database of claim 2 wherein the marker includes data specifying a permission attribute.
